(19) United States
(12) Patent Application Publication
(10) Pub. No.: US 2022/0410505 A1
(43) Pub. Date: Dec. 29, 2022

(54) FIBER REINFORCED THERMOPLASTIC COMPOSITE SHEET AND METHOD FOR PREPARING THE SAME

(71) Applicant: COVESTRO INTELLECTUAL PROPERTY GMBH & CO. KG, Leverkusen (DE)

(72) Inventors: Song WANG, Haerbin City (CN); Yilan LI, Shanghai (CN); Guidong QI, Shanghai (CN); Jinbao XIANG, Shanghai (CN)

(21) Appl. No.: 17/778,030

(22) PCT Filed: Nov. 19, 2020
(86) PCT No.: PCT/EP2020/082613

§ 371 Date: May 19, 2022

(30) Foreign Application Priority Data
Nov. 20, 2019 (CN) 201911152241.7
Feb. 6, 2020 (EP) 20155834.3

(51) Int. Cl. B29C 70/34; B29C 70/54; B29C 70/20

(52) U.S. Cl. CPC B29C 70/345; B29C 70/545; B29C 70/20; B29L 2007/002

(57) ABSTRACT

The present application relates to a fiber reinforced thermoplastic composite sheet and a method for preparing the same. The fiber reinforced thermoplastic composite sheet has on its surface a marble texture effect obtained by laminating cut pieces of a continuous fiber reinforced thermoplastic composite unidirectional tape, wherein the fibers and the resin used in the continuous fiber reinforced thermoplastic composite unidirectional tape have different colors. The thermoplastic composite sheet may be prepared using a simple and quick method, and meet individual requirements of surface appearance of the final product.

### FIELD OF THE INVENTION

The present invention relates to the field of composites. In particular, the present invention relates to a fiber reinforced thermoplastic composite sheet and a method for preparing the same.

### BACKGROUND ART

A continuous fiber reinforced thermoplastic composite is a composite of a thermoplastic resin matrix and reinforcing fibers produced by impregnating continuous fibers with a thermoplastic resin matrix under strictly controlled conditions. It is used in many fields such as automobile, aerospace, electrical and electronic, and mechanical fields, due to advantages in high specific modulus, high specific strength, short molding cycle, and no chemical reaction during molding etc.

The fibers used for preparing the continuous fiber reinforced thermoplastic composite mainly include carbon fibers, aramid fibers and the like.

Carbon fiber (CF for short) is a high-strength and high-modulus specialty fiber with a carbon content of more than 90%. It is characterized with high temperature resistance, antifriction, electric conduction, heat conduction and corrosion resistance etc., and is fibrous in appearance, soft and capable of being processed into various fabrics. Since its graphite microcrystalline structure is optimally oriented along the fiber axis, it has very high strength and modulus along the fiber axis direction. It also has high specific strength and high specific modulus due to its low density. The carbon fiber is mainly used as a reinforcing material to be compounded with resins, metals, ceramics, carbon and the like to produce an advanced composite. Among existing engineering materials, the carbon fiber reinforced epoxy resin composite has the highest specific strength and specific modulus.

Aramid, which possesses excellent properties such as ultra-high strength, high modulus, high temperature resistance, acid and alkali resistance, light weight, insulation, anti-aging and long life cycle, is widely used in fields such as composites, bulletproof products, building materials, special protective clothing and electronic equipment.

The continuous fiber reinforced thermoplastic composite is mainly produced by methods including a melt extrusion method, a film method, a solution method, or a powder method etc. The melt extrusion method involves forming a composite by impregnating continuous fibers with a melt of a thermoplastic resin, which features complete impregnation and low cost. The film method involves forming a prepreg by placing continuous fibers between two layers of resin films, and then melting the resin at a suitable temperature, followed by pressurization. The solution method generally involves preparing a low-viscosity solution by employing a suitable solvent to dissolve a resin, impregnating fibers with the resulting solution, and then volatilizing the solvent to produce a composite. The powder method is a method for preparing a prepreg by applying a powdery resin to a reinforcing material. The continuous carbon fiber reinforced thermoplastic composite unidirectional tape is also a kind of prepreg, continuous carbon fiber therein are parallel to each other, the unidirectional tape generally having a thickness of 0.10 to 0.25 mm.

Current continuous fiber reinforced thermoplastic composites are mostly unidirectional or woven fibers combined with a colorless transparent thermoplastic resin. Their colors and textures are relatively monotonous. Thus, it is necessary to develop more composites with different surface textures for producing customized products.

The patent application CN 109263050A discloses a fiber reinforced composite having a wood grain effect and a method for preparing the same. In this patent, the wood grain effect at the cross section is mainly achieved by preparing a composite using a thermosetting resin, and cutting the material. This involves immersing carbon fiber cloth or glass fiber cloth in a first resin, preferably an epoxy resin; covering one side of the carbon fiber cloth or glass fiber cloth immersed in the first resin with a colored second resin in a semi-cured state, wherein the second resin is preferably formed by blending a two-component epoxy resin with an epoxy resin color paste and a diluent. The above step is repeated until a laminated structure is formed and molded at a certain temperature and pressure; then it is cut from a top surface or bottom surface in a direction inclined toward the direction of the central axis perpendicular to the top surface or bottom surface to form a fiber material having a wood grain effect. This patent only involves s a thermoset resin composite having the texture effect merely at the cross section rather than at the upper and lower surfaces.

CN107443825A discloses a marble-like composite sheet comprising a TPU sheet layer, a fibrous material layer and a marble-like coating layer connected one after another. Through the arrangement of the marble-like coating layer, the marble-like composite sheet has the quality, luster and texture of natural marble. However, the marble-like texture of the marble-like composite sheet is prone to disappear due to wear of the coating layer.

Therefore, there is still a demand in the art for composites having a permanent surface texture.

### SUMMARY OF THE INVENTION

An object of the present invention is to provide a composite having a texture effect on a surface.

Another object of the present invention is to provide a method for preparing a composite having a texture effect on a surface.

Thus, according to a first aspect of the present invention, there is provided a fiber reinforced thermoplastic composite sheet, characterized in that the composite sheet has on its surface a marble texture effect obtained by laminating cut pieces of a continuous fiber reinforced thermoplastic composite unidirectional tape, wherein the fibers and the resin used in the continuous fiber reinforced thermoplastic composite unidirectional tape have different colors.

According to a second aspect of the present invention, there is provided a method for preparing the above fiber reinforced thermoplastic composite sheet, comprising the steps of:

I) cutting the continuous fiber reinforced thermoplastic composite unidirectional tape into pieces; and

II) tiling the resulting pieces in a mold and subjecting them to hot press molding, to form a fiber reinforced thermoplastic composite sheet having a marble texture effect on its surface.

The fiber reinforced thermoplastic composite sheet has a permanent marble texture effect on its surface, and thus can be used in applications having surface appearance requirements, such as automotive interiors. The thermoplastic composite sheet may be prepared using a simple and quick method, and meet individual requirements of surface appearance of final products.

### BRIEF DESCRIPTION OF THE DRAWINGS

The present invention will be described and explained below in more details in conjunction with the drawings, wherein:

FIG. 1 shows a carbon fiber reinforced thermoplastic composite sheet prepared from Example 1;

FIG. 2 shows a carbon fiber reinforced thermoplastic composite sheet prepared from Example 2.

### DETAILED DESCRIPTION OF THE INVENTION

Some embodiments of the present invention are now described in reference to the drawings for the purpose of illustration rather than limitation.

According to the first aspect of the present invention, there is provided a fiber reinforced thermoplastic composite sheet, characterized in that the composite sheet has on its surface a marble texture effect obtained by laminating cut pieces of a continuous fiber reinforced thermoplastic composite unidirectional tape, wherein the fibers and the resin used in the continuous fiber reinforced thermoplastic composite unidirectional tape have different colors.

Preferably, the resin used in the unidirectional tape is selected from the group consisting of polycarbonate (PC), thermoplastic polyurethane (TPU), polymethyl methacrylate (PMMA), polypropylene (PP), polyethylene terephthalate (PET) or a combination thereof.

Preferably, the fibers are selected from carbon fibers or aramid fibers. The fibers may be undyed or dyed.

In some embodiments, the fibers are undyed.

In some embodiments, the fibers are dyed prior to being used to reinforce a resin.

The resin used in the unidirectional tape may be unpigmented or pigmented.

In some embodiments, the resin used in the unidirectional tape is unpigmented, and the fibers are undyed or dyed.

In some embodiments, the resin is pigmented, and the fibers are undyed or dyed.

Preferably, the unidirectional tape has a thickness of between 0.10 and 0.25 mm.

Preferably, the fibers in the unidirectional tape have a content by volume of 35% to 60%.

The fiber reinforced thermoplastic composite sheet according to the present invention may be prepared by a simple and quick method.

According to the second aspect of the present invention, there is provided a method for preparing the above fiber reinforced thermoplastic composite sheet, comprising the steps of:

I) cutting the continuous fiber reinforced thermoplastic composite unidirectional tape into pieces; and

II) tiling the resulting pieces in a mold and subjecting them to hot press molding, to form a fiber reinforced thermoplastic composite sheet having a marble texture effect on its surface.

Preferably, the unidirectional tape has a thickness of between 0.10 and 0.25 mm.

Preferably, the fibers in the unidirectional tape have a content by volume of 35% to 60%.

The unidirectional tape is commercially available or self-prepared.

The continuous fiber reinforced thermoplastic composite unidirectional tape may be prepared by impregnating continuous fibers with a resin. The impregnation method may be a method commonly used in the art, for example, a melt extrusion method, a film method, a solution method, or a powder method etc., preferably a melt extrusion method.

In some embodiments, the method further comprises preparing a continuous fiber reinforced thermoplastic composite unidirectional tape by impregnating continuous fibers with a resin.

The resin used in the continuous fiber reinforced thermoplastic composite unidirectional tape may be selected from the group consisting of polycarbonate (PC), thermoplastic polyurethane (TPU), polymethyl methacrylate (PMMA), polypropylene (PP), and polyethylene terephthalate (PET).

When it is desired to obtain a fiber reinforced thermoplastic composite sheet in the form of a colored sheet, this may be achieved by enabling the continuous fiber reinforced thermoplastic composite unidirectional tape to exhibit a colored unidirectional tape, for example, using colored fibers and/or colored resin in the preparation of the continuous fiber reinforced thermoplastic composite unidirectional tape, or covering the continuous fiber reinforced thermoplastic composite unidirectional tape with a colored resin film.

In some embodiments, the continuous fiber reinforced thermoplastic composite unidirectional tape is a colored fiber reinforced thermoplastic composite unidirectional tape, the method further comprising providing a colored continuous fiber reinforced thermoplastic composite unidirectional tape.

For example, in some specific embodiments, the unidirectional tape is a colored unidirectional tape, the method further comprising preparing the colored unidirectional tape using continuous fibers and a resin, wherein at least one of the fibers and the resin is colored.

In some embodiments, the unidirectional tape is a colored unidirectional tape, the method further comprising preparing the colored unidirectional tape using continuous fibers and a resin, wherein only the fibers are colored.

In some embodiments, the unidirectional tape is a colored unidirectional tape, the method further comprising preparing the colored unidirectional tape using continuous fibers and a resin, wherein only the resin is colored.

In some embodiments, the unidirectional tape is a colored unidirectional tape, the method further comprising preparing the colored unidirectional tape using continuous fibers and a resin, wherein both of the fibers and the resin are colored.

In some embodiments, the method according to the present invention comprises the steps of:

I) impregnating continuous fibers with a colored thermoplastic resin to form a continuous fiber reinforced thermoplastic composite unidirectional tape, wherein the fibers and the resin have different colors;

II) cutting the continuous fiber reinforced thermoplastic composite unidirectional tape obtained in step I) into pieces; and

III) tiling the pieces in a mold and subjecting them to hot press molding, to form a fiber reinforced thermoplastic composite sheet having on its surface a marble texture effect.

In some embodiments, the method according to the present invention comprises the steps of:

I) impregnating colored continuous fibers with an unpigmented thermoplastic resin to form a continuous fiber reinforced thermoplastic composite unidirectional tape;

II) cutting the continuous fiber reinforced thermoplastic composite unidirectional tape obtained in step I) into pieces; and

III) tiling the pieces in a mold and subjecting them to hot press molding, to form a fiber reinforced thermoplastic composite sheet having on its surface a marble texture effect.

In some embodiments, the method according to the present invention comprises the steps of:

I) impregnating colored continuous fibers with a pigmented thermoplastic resin to form a continuous fiber reinforced thermoplastic composite unidirectional tape, wherein the fibers and the resin have different colors;

II) cutting the continuous fiber reinforced thermoplastic composite unidirectional tape obtained in step I) into pieces; and

III) tiling the pieces in a mold and subjecting them to hot press molding, to form a fiber reinforced thermoplastic composite sheet having on its surface a marble texture effect.

In some embodiments, the method comprises, prior to cutting the unidirectional tape into pieces, covering one or both sides of the unidirectional tape with a colored resin film, and laminating the unidirectional tape and the colored resin film by hot press molding, and then cutting the unidirectional tape and the colored resin film together into pieces.

By introducing the colored resin film on the basis of the original continuous fiber reinforced thermoplastic composite unidirectional tape, cutting them into pieces and then hot pressing to form a fiber reinforced thermoplastic composite sheet having a marble texture effect on its surface, it is possible to quickly screen different colored marble texture effects, save production costs, increase efficiency, and provide reference solutions for mass production.

The colored resin film is formed with a pigment-containing polycarbonate (PC), a thermoplastic polyurethane (TPU), a polymethyl methacrylate (PMMA), a polypropylene (PP) or a polyethylene terephthalate (PET) resin.

The colored resin film is commercially available or self-prepared.

Therefore, the method according to the present invention may further comprise a step of preparing a colored resin film using pigment-containing thermoplastic resin particles.

In some embodiments, the method according to the present invention comprises the steps of:

I) impregnating continuous fibers with an unpigmented transparent or translucent first thermoplastic resin to form a continuous fiber reinforced thermoplastic composite unidirectional tape;

II) melt-extruding pigmented second thermoplastic resin particles to form a colored resin film;

III) covering one or both sides of the continuous fiber reinforced thermoplastic composite unidirectional tape obtained in step I) with the colored resin film obtained in step II), and laminating the unidirectional tape and the colored resin film by hot press molding;

IV) cutting the continuous fiber reinforced thermoplastic composite unidirectional tape covered with the colored resin film obtained in step III) into pieces; and

V) tiling the pieces in a mold and subjecting them to hot press molding, to form a fiber reinforced thermoplastic composite sheet having on its surface a marble texture effect.

There is no requirement as to the sequence of the step of forming the fiber reinforced thermoplastic composite unidirectional tape and the step of forming the colored resin film.

Preferably, the first thermoplastic resin and the second thermoplastic resin are independently selected from the group consisting of polycarbonate (PC), thermoplastic polyurethane (TPU), polymethyl methacrylate (PMMA), polypropylene (PP), and polyethylene terephthalate (PET).

More preferably, the first thermoplastic resin and the second thermoplastic resin are resins of the same type.

Preferably, the colored resin film has a thickness of 0.04 to 0.10 mm.

A person skilled in the art may determine the temperature and pressure for hot pressing the unidirectional tape and the colored resin film, according to the materials used in the unidirectional tape and the colored resin film.

In some embodiments, the unidirectional tape and the colored resin film are laminated by hot press molding at a temperature of 170 to 180° C. and a pressure of 1 to 2 MPa.

The resulting pieces may be in any shapes, such as rectangular, triangular or circular.

The resulting pieces may also be of any suitable sizes.

For example, when the pieces are rectangular, they may have a length of 5 to 50 mm and a width of 5 to 50 mm.

When the pieces are triangular, circular or irregular, they may have a nominal size of 5 to 50 mm.

In the present application, the nominal size refers to the size of side length of a square having the same area as the pieces.

A person skilled in the art may also determine the temperature and pressure for hot press molding of the pieces, according to the materials used in the unidirectional tape and the optional colored resin film.

In some embodiments, the pieces are hot press molded into the composite sheet at a temperature of 160 to 230° C. and a pressure of 1 to 5 MPa.

In some embodiments, the pieces are hot press molded into the composite sheet at a temperature of 160 to 230° C. and a pressure of 2 to 3 MPa.

The descriptions of various features in the present application can be combined when there is no contradiction, and they all fall within the scope claimed by the present application.

The terms “comprising” and “including” described in present application cover the circumstances which further comprise or include other elements not specifically mentioned and the circumstances consisting of the elements mentioned.

Unless otherwise defined, all technical and scientific terms used herein have the same meaning as commonly understood by those skilled in the field the present invention belongs to. When the definition of a term in the present description conflicts with the meaning as commonly understood by those skilled in the field the present invention belongs to, the definition described herein shall apply.

Unless otherwise specified, all numerical values expressing amount of ingredients, reaction conditions and the like used in the description and claims are to be understood as being modified by the term “about”. Accordingly, unless indicated to the contrary, the numerical values and parameters described herein are approximate values which are capable of being changed according to the desired performance obtained as required.

### EXAMPLES

The concept, specific structure and technical effects of the present invention will be further described below in conjunction with the examples and drawings so that a person skilled in the art can fully understand the objects, features and effects of the present invention. It will be readily understood by a person skilled in the art that the examples herein are for illustrative purposes only and the scope of the present invention is not limited thereto.

The Equipment Used

Name of the Pressing Machine: Static Hot Pressing Machine (Model BL-6170-B ) manufactured by Dongguan Baolun Precision testing Instrument Co., Ltd.

### Example 1

A carbon fiber reinforced polycarbonate composite sheet was prepared in accordance with the following steps:

first, impregnating continuous carbon fibers with a white polycarbonate composition to form a continuous carbon fiber reinforced polycarbonate composite unidirectional tape having a thickness of 0.17 mm and a fiber content by volume of 44%;

next, cutting the resulting continuous carbon fiber reinforced polycarbonate composite unidirectional tape into pieces having a size of 20 mm×10 mm;

then tiling the pieces in a mold and subjecting them to hot press molding at a temperature of 170° C. and a pressure of 2 MPa for 10 minutes, to form a carbon fiber reinforced polycarbonate composite sheet having a marble texture effect on its surface and a thickness of 1 mm.

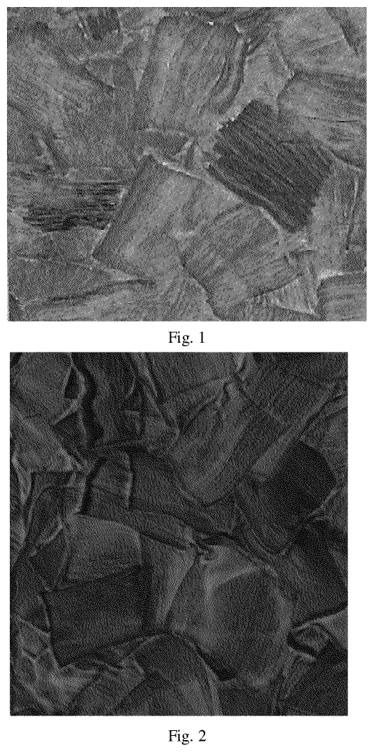

A photo of the surface of the resulting carbon fiber reinforced polycarbonate composite sheet was taken, and the photo was illustrated in FIG. 1.

### Example 2

A carbon fiber reinforced polycarbonate composite sheet was prepared in accordance with the following steps:

first, impregnating continuous carbon fibers with an unpigmented polycarbonate resin to form a continuous carbon fiber reinforced polycarbonate composite unidirectional tape having a thickness of 0.17 mm and a fiber content by volume of 44%;

next, extruding polycarbonate resin pellets containing a green pigment to form a polycarbonate film having a thickness of 0.04 mm;

covering the resulting polycarbonate film on both sides of the continuous carbon fiber reinforced polycarbonate composite unidirectional tape, and bonding the film and the unidirectional tape together at a temperature of 170° C. and a pressure of 2 MPa;

next, cutting the film and the unidirectional tape into pieces having a size of 20 mm×10 mm;

then tiling the pieces in a mold and subjecting them to hot press molding at a temperature of 170° C. and a pressure of 2 MPa for 10 minutes, to form a carbon fiber reinforced polycarbonate composite sheet having a marble texture effect on its surface and a thickness of 1.05 mm.

A photo of the surface of the resulting carbon fiber reinforced polycarbonate composite sheet was taken, and the photo was illustrated in FIG. 2.

The exemplary embodiments or examples of the present invention have been described above, but are not intended to limit the present invention. For persons skilled in the art, various modifications and changes can be made to the present invention. Any modification, equivalent replacement and improvement, etc. made within the spirit and principle of the present invention shall be included within the scope of the claims of the present application.

1.-15. (canceled)

16. A fiber reinforced thermoplastic composite sheet, wherein the composite sheet has on its surface a marble texture effect obtained by laminating cut pieces of a continuous fiber reinforced thermoplastic composite unidirectional tape, wherein the fibers and the resin used in the continuous fiber reinforced thermoplastic composite unidirectional tape have different colors.

17. The composite sheet according to claim 16, wherein the resin used in the unidirectional tape is selected from the group consisting of polycarbonate (PC), thermoplastic polyurethane (TPU), polymethyl methacrylate (PMMA), polypropylene (PP), polyethylene terephthalate (PET), and combinations thereof.

18. The composite sheet according to claim 16, wherein the fibers are selected from carbon fibers or aramid fibers.

19. The composite sheet according to claim 16, wherein the fibers are undyed or dyed.

20. The composite sheet according to claim 16, wherein the resin used in the unidirectional tape is unpigmented or pigmented.

21. The composite sheet according to claim 16, wherein the content by volume of fibers in the unidirectional tape is from 35% to 60%.

22. A method for preparing a fiber reinforced thermoplastic composite sheet according to claim 16, comprising the steps of:
I) cutting the continuous fiber reinforced thermoplastic composite unidirectional tape into pieces; and
II) tiling the resulting pieces in a mold and subjecting them to hot press molding, to form a fiber reinforced thermoplastic composite sheet having a marble texture effect on its surface.

23. The method according to claim 22, wherein the unidirectional tape has a thickness of between 0.10 and 0.25 mm.

24. The method according to claim 22, wherein the unidirectional tape is a colored unidirectional tape, the method further comprising preparing the colored unidirectional tape using fibers and a resin, wherein at least one of the fibers and the resin is colored.

25. The method according to claim 22, wherein the method comprises, prior to cutting the unidirectional tape into pieces, covering one or both sides of the unidirectional tape with a colored resin film and laminating the unidirectional tape and the colored resin film by hot press molding, and then cutting the unidirectional tape and the colored resin film together into pieces.

26. The method according to claim 25, wherein the colored resin film is formed with a pigment-containing polycarbonate (PC), a thermoplastic polyurethane (TPU), polymethyl methacrylate (PMMA), polypropylene (PP) or polyethylene terephthalate (PET) resin.

27. The method according to claim 25, wherein the colored resin film has a thickness of between 0.04 and 0.10 mm.

28. The method according to claim 25, wherein the unidirectional tape and the colored resin film are laminated by hot press molding at a temperature of 170 to 180° C. and a pressure of 1 to 2 MPa.

29. The method according to claim 22, wherein the pieces are rectangular, triangular or circular.

30. The method according to claim 22, wherein the pieces are subjected to hot press molding to form the composite sheet at a temperature of 160 to 230° C. and a pressure of 1 to 5 MPa.
